(19) United States
(12) Patent Application Publication
(10) Pub. No.: US 2008/0162715 A1
(43) Pub. Date: Jul. 3, 2008

(54) Method for securing a data stream

(75) Inventor: Jean-Philippe Wary, Bourg la Reine (FR)

Correspondence Address: PERMAN & GREEN, 425 POST ROAD, FAIRFIELD, CT, 06824, US

(73) Assignee: SOCIETE FRANCAISE DU RADIOTELEPHONE, Paris (FR)

(21) Appl. No.: 11/966,125

(22) Filed: Dec. 28, 2007

(30) Foreign Application Priority Data
Dec. 29, 2006 (FR) 0656064

(51) Int. Cl. G06F 15/16

(52) U.S. Cl. 709/231

(57) ABSTRACT

To manage the security of the communications coming from and sent to a mobile terminal, these communications including voice communications because the mobile terminals are capable of setting up communications known as voice on IP (VoIP), a local proxy server is installed in a local proxy server. This management is furthermore secured by protection via mechanisms of security of the configuration of the proxy server enabling the management of this security. This security is, by the same read/write mechanisms, managed in a centralized way through a server producing and broadcasting the configurations.

### BACKGROUND

1. Field

The aspects of the disclosed embodiments relate to a method for securing a data stream.

The field of the disclosed embodiments is that of electronic processing terminals. More particularly, the field of the disclosed embodiments is that of intelligent or smart mobile terminals.

2. Brief Description

The term “intelligent mobile terminal” is understood here to mean a mobile telephone of the second generation or above the second generation. By extension, a mobile terminal is any device that communicates through a network and can be carried without assistance by a human being. This category therefore includes at least mobile telephones, le signal digital assistants and laptops. These intelligent or smart terminals are capable of applying any use whatsoever. The preferred use of the disclosed embodiments will be achieved here below in the description by means of mobile telephones. The term “terminal” will therefore correspond here below to a mobile telephone. At the same time, the previous definition will be kept in mind.

It is one aim of the disclosed embodiments to secure the communications effected by a terminal. It is another aim of the disclosed embodiments to make management of the security of the communications of the terminal easy and certain.

It is another aim of the disclosed embodiments to enable easy delegation of the management of the security of communications of a fleet of terminals to a fleet manager, while at the same time enabling this manager to position elements at the level of each terminal of its fleet or for a set of terminals of its fleet and solely for this fleet.

There are no means in the prior art for a simple management of the security of communications of a terminal or fleet of terminals. Once a terminal is let out into the world, it is entirely dependent on its user's actions.

In the disclosed embodiments, this problem is resolved by implanting a local proxy server on the terminal. This proxy server processes at least one incoming or outgoing stream of the terminal by applying to this stream processing operations laid down by a configuration memory of the proxy server. These processing operations are performed by one or more application-specific software programs. It is therefore possible to secure these streams, for example by enciphering them or by analyzing their content at the syntactic or semantic level or even to search for occurrences of binary patterns or malicious code signatures to prevent interceptions or intrusions.

In one variant of the disclosed embodiments, this proxy server can also secure the data streams between the different components of the terminal, whether these components are software components (such as a software program for viewing a video or a text editor) or hardware components (such as a memory component that can be identified by a range of physical addresses or through a range of physical addresses and an interruption type addressing system or indexing element), and generally any typology of components that can be identified or indexed by the operating system of the terminal. This proxy server secures these streams by permitting or not permitting copying, shifting, or even access operations for reading, writing, rewriting all or part of a piece of data, a data file or a set of bit files which may correspond to a software program or a set of software programs which may correspond to a software program or a set of software programs or all or part of the operating system. This proxy server, in one variant of the disclosed embodiments, is also responsible for the secured or unsecured storage of these pieces of data or data files in the terminal and can dictate the use of cryptographic and/or encoding/compression.

In one variant of the disclosed embodiments, the proxy server and its configuration memory are recorded in a microcircuit card and are secured to ensure that the configuration memory is not deteriorated.

In the disclosed embodiments, the term “protocol” is understood in the commonly accepted sense i.e. it is used to communicate on a same level of extraction between two different machines. By extension of this meaning, the term “protocol” is also used to designate the rules of communications established between two layers on a same terminal or between a terminal and a microcircuit card. In the disclosed embodiments, the word “protocol” can be applied without distinction to a sequence of protocols between various communications layers (a stack of protocols as understood commonly) and to software programs implementing said protocols. In a preferred but not restrictive embodiment of the disclosed embodiments, the word “protocol” encompasses the TCP/IP, IPv4, IPv6, IPsec, SIGTRAN stacks, the set of services of level 2, 3, 4, 5 layers and above. By way of a non-restrictive indication, we may cite the following known protocols to illustrate the above: MPLS, PPP, ATM, IP, ARP, ICMP, BGP, OSPF, L2TP, RTP, SRTP, SCTP, TCP, UDP, TCAP, FTP, IRC, SSH, SSL and TSL, HTTP, IMAP, POP3, SMTP, Telnet, SIP, H323. In this preferred embodiment, the protocols of the IP world are often technically identified by the number of the destination port.

### SUMMARY

The aspects of the disclosed embodiments are directed to a method for securing a data stream sent out by an electronic terminal (101), the securing being obtained through a proxy server (115) hosted and implemented in a microcircuit card inserted in the electronic terminal, wherein the method comprises the following steps implemented by the terminal:

it records (201) a configuration of a proxy server in a configuration memory of the microcircuit card for which the rights to update the configuration memory of a set of terminals or fleet of terminals are dedicated to a single entity, the fleet manager, exclusively between fleets of terminals,

it records (202), in a protocol configuration memory, a parameter forcing the use of the proxy server for each data stream of at least one protocol,

it applies (204-206), for each data stream of each protocol parametrized to be submitted to the proxy server, the processing planned for the stream by the configuration of the proxy server.

In one variant, the method of the disclosed embodiments is also characterized in that the planned processing is carried out by a dedicated application-specific program.

In one variant, the method of the disclosed embodiments is also characterized in that the planned processing is carried out by a specialized server connected to the proxy server.

In one variant, the method of the disclosed embodiments is also characterized in that the configuration memory is updated through an updating step (213) following a step of remote connection to the terminal comprising the configuration memory.

In one variant, the method of the disclosed embodiments is also characterized in that the configuration memory is updated through an updating step (213) following a step of connection locally to the terminal comprising the configuration memory, this connection step possibly necessitating a phase of authentication of the user.

In one variant, the method of the disclosed embodiments is also characterized in that a step of writing in the configuration memory is conditioned by the validation of a step (212) of verification of the rights of the sender of a request for updating the configuration memory.

In one variant, the method of the disclosed embodiments is also characterized in that the application programs responsible for the processing operations planned for each of the streams identified by the configuration of the proxy server are updated according to the same methods as those set up for updating the configuration memory, where this updating can be limited to the downloading of cryptographic keys using symmetric or asymmetric technologies necessary for the working of said application program.

In one variant, the method of the disclosed embodiments is also characterized in that the proxy server is implemented by a microcircuit card inserted into the electronic terminal.

In one variant, the method of the disclosed embodiments is also characterized in that the processing planned for each of the data streams of each parametrized protocol takes account of the information on the time of use.

In one variant, the method of the disclosed embodiments is also characterized in that the processing operation planned for each of the data streams of each parametrized protocol takes account of the knowledge of the geolocation of the terminal.

In one variant, the method of the disclosed embodiments is also characterized in that the processing planned for each of the data streams of each parametrized protocol takes account of the information on the last streams processed.

In one variant, the method of the disclosed embodiments is also characterized in that the application-specific programs dedicated to the planned processing may be downloaded into the microcircuit card or activated if they are already resident therein.

In one variant, the method of the disclosed embodiments is also characterized in that there is a default security configuration applied to any new terminal of the fleet that does not have any specific configuration.

### BRIEF DESCRIPTION OF THE DRAWINGS

The disclosed embodiments will be understood more clearly from the following description and the accompanying figures. The figures are given by way of an indication and in no way restrict the scope of the disclosed embodiments. Of these figures:

FIG. 1 illustrates means in which the disclosed embodiments are implemented,

FIG. 2 illustrates steps of the method according to the disclosed embodiments.

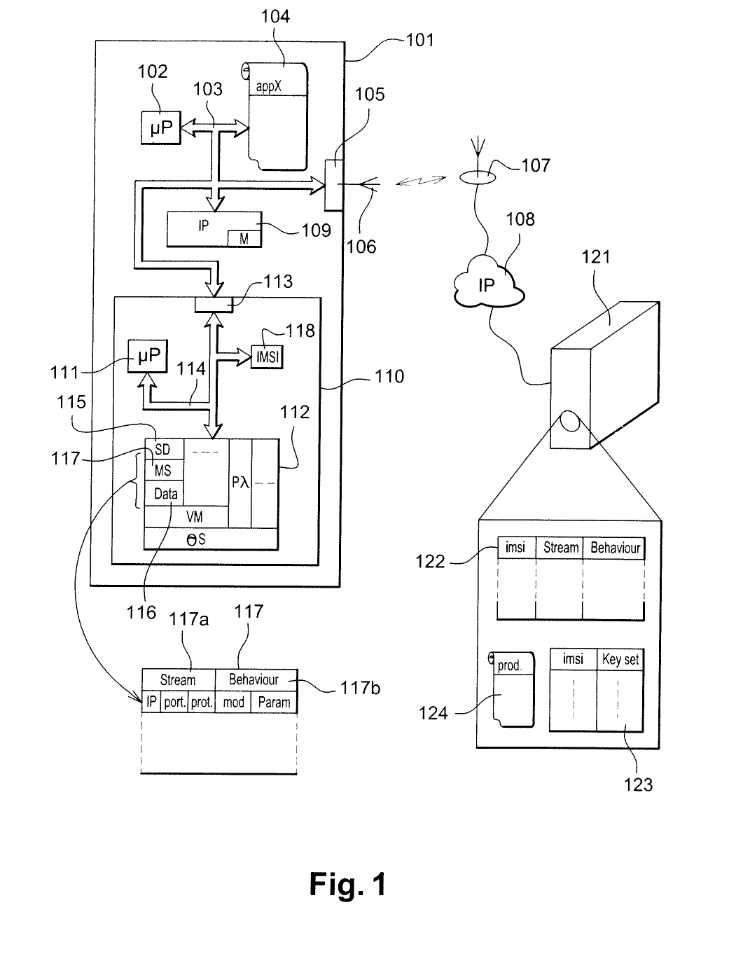

FIG. 1 shows a mobile terminal 101. For the description and by way of an example, the terminal 101 is considered to be a mobile telephone.

The terminal 101 comprises a microprocessor 102 connected via a bus 103 to a program memory 104.

### DETAILED DESCRIPTION

In this description, when an action is attributed to a device, this action is actually performed by a microprocessor of the device controlled by instruction codes recorded in a program memory of the device. Similarly, when an action is attributed to an application/program, this application/program corresponds in fact to a series of instruction codes recorded in a program memory of the device implementing the application. This series of instruction codes is implemented by a microprocessor of said device.

The terminal 101 also has interface circuits 105 between the bus 103 and an antenna 106. The circuits 105 carry out a conversion between the signals of the bus 103 and the signals received/sent through the antenna 106. These circuits are therefore a radioelectrical interface enabling the terminal 101 to communicate in a mobile telephony network taking the form of a base station 107. Through these circuits 105 and the mobile telephony network 107, the terminal 101 is capable of communicating on an Internet type network 108 and is therefore capable of reaching or being reached by any server or terminal connected to this network 108.

The terminal 101 also has a network configuration memory 109 and more particularly here a TCP/IP communications configuration memory. This configuration comprises at least one parameter M indicating whether it is necessary to use a gateway for the incoming/outgoing streams of the telephone. In the case of the disclosed embodiments, the parameter M is equal to the IP address of the proxy server or proxy. According to the disclosed embodiments, this address is advantageously the local IP address or localhost i.e. for the IPV4 protocol it is 127.0.0.1 or the virtual Ethernet address (loopback) in the case of the Ethernet protocol. This means that all the incoming/outgoing streams will be processed by the proxy server according to the disclosed embodiments.

This gateway can also be identified by a specific naming or name assignment, directly processed by the IP stack of said telephone during the resolution of the names, for example the use of an “sc” or “simcard” type prefix instead of the “www” commonly used for browsing on the web. For example, the fact of entering the address “cartesim.sfr.fr” or “cartesim.www.sfr.fr” instead of “www.sfr.fr” enables the IP stack of the terminal to be informed that an attempt is being made to access the site www.sfr.fr through the local proxy server identified at the level of the configuration file of the mobile phone by the prefix “cartesim” or “simcard”. In this case, the request is directly sent to the local proxy server. This naming technique makes it possible, in one variant of the disclosed embodiments, to address several proxy servers at the telephone level, each being provided with its own configuration file and/or servers and dedicated application programs for processing operations specific to the transferred stream.

It will have been understood here that the proxy server is actually a program implemented by a microprocessor of the terminal 101. FIG. 1 again shows that the terminal 101 comprises a microcircuit card 110. The microcircuit card 110 has a microprocessor 111, a program memory 112 and interface circuits 113 for interfacing with the bus 103. The elements 111 to 113 are interconnected through a bus 114.

The memory 112 is structured in layers so as to enable an isolation of the applications implemented by the microprocessor 111.

Such an architecture is, for example, a purely software architecture implementing the concept of security domains. A security domain is defined at the level of the operating system of the mobile telephone or of a super-layer or over-layer of the operating system. Such an over-layer is for example of virtual machine of the Java type, or even the multi-applications system for chip cards known as GlobalPlatform (www.globalplatform.org).

The security domain comprises a least one memory zone divided into a program zone and a data zone. The mechanisms of the exploitation system or of the over-layer ensure that the instruction codes of the program zones of a security domain can access only data of the data zone of said security domain. This access to the security domain is furthermore protected by a set of keys. Thus, there are several keys associated with a security domain. Thus, the field of the technique introduces the notion of a set of keys (or “keyset”) that participates in the protection of the security domain, each of these keys being dedicated to one highly precise security role or function depending on the needs of securitisation of the security domain. The following list of security keys or functions is not exhaustive but, for the securing of a domain, several keys may be used within a same keyset depending on the security needs proper to the domain considered. Thus, there may be one key to instantiate services in the security domain, one key to activate these services, one key to authenticate access to these services, one key to encipher communications with these services and one key to modify these parameters of the security domain, i.e. to modify the content of the data zone of said domain. Only knowledge of the right key or of a means of access to the right key then makes it possible to undertake the desired action. Depending on the modes of management of the keys implemented, there may be one dedicated keyset for a domain, for a set of microcircuit cards, or one dedicated keyset for the domain identified for each of the microcircuit cards of the set considered.

These mechanisms ensure efficient compartmentalisation or isolation of data between the different security domains should the underlying operating system implement adequate isolation (implying the notion of firewalling or the sandbox by Java).

In the context of the Java chip card world (JavaCard™) and of the <<Global Platform>>(http://www.globalplatform.org/), the notion of the security domain is thus proposed.

One alternative to this software application consists of the use of a dedicated chip card emulating the working of a security domain.

In a preferred mode of implementation, the memory 112 therefore has a security domain comprising instruction codes corresponding to a proxy server according to the disclosed embodiments and data corresponding firstly to a configuration of the proxy server and secondly to optional modules. A module is a memory zone comprising instruction codes corresponding to functions of the proxy server.

By virtue of its inclusion in a security domain 115, the proxy server and its data zones are protected by a keyset. The keys of this keyset are then known only to the operator of the service providing security to the subscriber using the terminal 101.

Here below, the security domain 115 is identified with the proxy server itself. Indeed, this security domain comprises at least the instruction codes corresponding to the proxy server as well as the configuration data of the proxy server.

Among the possible modules 117, we may cite at least protection against incoming connections depending on their source addresses and/or their destination and source ports, the filtering of outgoing connections as a function of their destination addresses and/or their destination and source ports, antivirus, syntax and semantics checking applications, setting up secured connections by setting up virtual private networks (VPN) which may or may not be enciphered with or without simple or mutual authentication, the enciphering/deciphering of sent/received data etc (this list is not exhaustive), and the setting up and management of the different cryptographic keys or electronic certificates needed to deliver the services listed here above.

The data 116 of the security domain 112 comprise at least one table 117 used to associate a stream 117a with a behavior 117b of the proxy server.

A data stream is characterized by a network context comprising at least, in the case of IP communications, an IP address and a port number. In an exhaustive way, a stream may also be identified by two IP addresses (source and destination), two port numbers (source and destination) and one protocol identifier (destination port). The term generally used is “quintuplet” which enables a stream to be identified. The processing operations on the streams can also be characterized relative to a notion of time or a notion of geolocation. It must indeed be possible to prohibit certain sensitive streams when the mobile is situated in a foreign country for example or when it is desired to communicate highly confidential data outside opening hours when there is nobody present to collect or process this data.

In one variant of an implementation, the data stream is characterized by a source and a destination within the terminal: a set of data files stored in the terminal or a software or hardware component and an operation to be performed: (the following is a non-exhaustive list) reading, writing, copying, destroying, supplementing, adding, enciphering/decipher without without indication of keying, decompressing and generally all the operations commonly performed on a data file.

A behavior is characterized by a module identifier in the memory 117 and parameters for this module.

Each row of the memory 117 therefore associates a stream with a behavior for this stream.

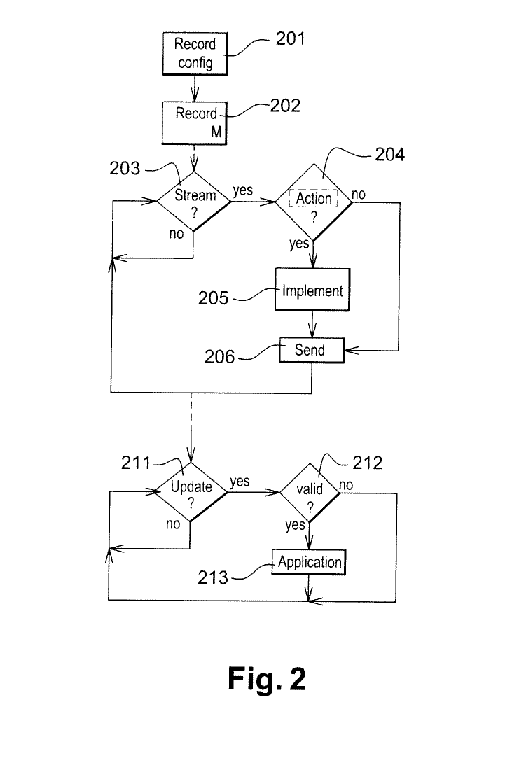

FIG. 2 shows a 201 for recording a configuration of the proxy server. In this step, the table 117 is updated by an operator who knows the updating key of the domain 115. The terminal 101 receives updating messages through the network 108 or another interface (not described) of the terminal 101.

These messages have at least one instruction code for updating the memory 117 and data for the updating. This updating message may be signed by using the ad hoc key of the key set. This enables the card to verify the validity of the updating message, its origin (authentication) to check its integrity or even to check that the card is the right recipient of the message and to take account of this if the message is valid. Taking the updating message into account amounts to using the data of the updating message to update the table 117.

Here, we observe a first point of utility of the disclosed embodiments. It is indeed possible, for a manager of a fleet of terminals, to plan for a security configuration, in a central server, for each terminal of the fleet of terminals. The central server therefore has a data base associating a user with a keyset and a security configuration. When the security configuration is modified, the server automatically sends out the security configuration message in using the data and therefore the associated rights of the keyset of the microcircuit card of the terminal considered to the terminal whose security configuration has been modified on the central server.

In one variant, the central server can manage a set of specific application programs that can be loaded into the security domains of the card to perform processing operations specific to certain streams. It is thus possible to envisage the regular updating of these application programs for each of the terminals, download or activate those that are already resident in the terminal or terminals, push a specific security configuration to a terminal according to the profile of the user of said terminal and varyingly sensitive uses of this terminal.

In a preferred variant of the disclosed embodiments, there is a default security configuration applied to any new terminal of the fleet that does not have a specific configuration. It is also possible to define groups of terminals. The modification of the security configuration of the group prompts the sending of as many configurations messages as there are terminals in the group.

The step 201 may in fact take place at any time, thus making it possible also to block the communications of the terminal through very restrictive rules. FIG. 2 also shows a step 202 for the recording of a configuration of the memory 109. This configuration step comprises at least the recording of an address of the local proxy server. This configuration has the effect of forcing all the incoming and outgoing streams of the terminal 101 to be processed by the local proxy server.

In a preferred variant of the disclosed embodiments, the proxy server is implemented by a microcircuit card. This is made relevant by a development of the technology which enables a microcircuit card to directly access the communications resources of the terminal through the new card technologies known as BIP (bearer independent protocol) technologies. These technologies enable the microcircuit card to access the network at high bit rates.

This implementation gives an additional guarantee at the level of the implementation of the disclosed embodiments. Indeed, the network 107 is capable of identifying the source of a stream depending on whether it comes from a microcircuit card or directly from a terminal. In the context of the deployment of the disclosed embodiments, in a preferred variant, the network 107 is configured to reject streams that do not come from a microcircuit card. This configuration is optional and may relate only to a given list of terminals.

In another variant of the disclosed embodiments, the configuration of the memory 109 is subjected to the validation of a password so as to prohibit avoidance of the proxy server.

Thus, it is reasonably guaranteed that all the incoming/outgoing streams of the terminal 101 will be processed by the proxy server implemented by the card 110.

In a preferred variant of the disclosed embodiments, the card 110 is a SIM/USIM (Subscriber Identification Module) card of a mobile telephony operator who is then also a security operator. In this variant, it is simple for the mobile network operator, managing and controlling his own SIM/USIM cards, to delegate certain keyset values to customer entities who are users of a large number of SIM/USIM cards (this entails the notion of the big account). These big accounts then manage fleets of terminals and SIM/USIM cards and can implement an entity that is a manager of their mobile fleets. For each of these big accounts, the fleet manager has access solely to the SIM/USIM cards and to the domains authorised by the operator through keysets made available to him, by the operator. This process of making keysets available can take several forms, which do not restrict the scope of the disclosed embodiments: there may be a simple secure transfer of the values of the set of keysets of its fleet, a mechanism of delegation through a web type service platform of the operator whose access is of course secured or even a mechanism of delegation under the control of the operator on an asymmetric cryptographic basis integrated into the SIM/USIM cards/terminals. This “big accounts” fleet manager can then easily and surely manage the default security policies of each of its some cards/terminals both by the use of the default security policy and by the setting up of a specific security policy according to certain sensitive profiles of his fleet.

In other variants, it is a microcircuit card which may or may not be dedicated, or a program situated in the memory 104 i.e. without implementation of a microcircuit card.

The terminal 101 then goes to a waiting step 203 in which a process monitors the event that must manage the terminal 101 and assigns their management to the right task. In this case, the terminal 101 behaves like any multi-tasking system.

In the step 203, if it is detected that streams have been sent then, depending on the configuration of the memory 109, the terminal hands over control to the local proxy server.

In a step 204, the local proxy server designated here below as the proxy takes charge of the management of the stream. Actions are therefore attributed to the proxy which is herein identified with the card 110. In practice, the card 110 also has other functions.

In one variant of the disclosed embodiments, the step 203 is performed by the operating system which detects the fact that a final system of data files will undergo processing at the level of the terminal. The operating system then identifies the type of stream and subjects this information as well as the stream to the proxy server in the step 204. The proxy server then applies the processing operations identified for this type of stream in the table 117 and passes to the step 205 and implements these processing operations on the data files before making them available to the intended recipient in the terminal.

In the step 204, the proxy identifies the stream to be processed according to information transferred to it by the terminal 101. For the requirements of the description, this stream is submitted to the proxy in the form of a succession of messages comprising a description of the stream and the data of the stream. The description of the stream comprises at least one address on the network, in this case IP network, and a port identifier and/or a protocol identifier.

In one variant of the disclosed embodiments, the proxy has knowledge of the local time of the terminal and takes account of this piece of information once the processing operations have been applied to the streams.

In one variant of the disclosed embodiments, the proxy has knowledge of the geolocation of the terminal and takes account of this information once the processing operations have been applied to the streams.

This description of the stream enables the proxy to make a search in the table 117. In the step 204, the proxy searches the table 117 for a row for which the values of the fields corresponding to the column 117a are equal to the values describing the stream. A search therefore has to be made in the column 117a for an IP address and a port/protocol identifier.

If the search is successful, then the proxy passes to a step 205 for implementing actions corresponding to the row found in the step 204. If not, i.e. if the search is unsuccessful, the proxy passes to a step 206 for sending the stream.

It is noted here that the memory 117 can comprise a row describing a default behavior of the proxy. This default behavior may be highly restrictive, i.e. it may prohibit the sending/reception of any stream that does not correspond to another row in the table 117. This default configuration is then the last row of the table 117. The search for a row in the table stops as soon as a row corresponding to the stream has been found. In this implementation and in another, it is possible to use “wildcard characters” to describe all or part of a characteristic of the stream. A wildcard character is a character valid for any series of characters, for example, *-*(port-address) is valid for all the streams,*-80 is valid for all http .192.168.0 streams, *-*is valid for all streams on the network 192.168.0.0/24. The list is not exhaustive.

In a step 205, the proxy uses the data of the column 117b corresponding to the row found in the step 204 to process the data of the stream. These instructions are, for example, non-restrictively:

block the stream,

let the stream pass,

search and destroy viruses that could contain the stream,

encipher/decipher the stream,

encipher/decipher a part of the stream, especially in the case of a messaging stream where it may be useful to encipher information conveyed but not information on the transport protocol of this message.

set up/use a tunnel to send the data,

send a trace identifying and characterizing the nature of the connection set up, the characteristics of this connection, the processing operations performed by the proxy server on this connection, this trace being possibly kept locally in the SIM card or sent to the mobile and/or an external server.

Once the stream is processed in the step 205, the proxy goes to the step 206 in which the stream is sent by the proxy. If the stream is blocked, it is naturally not sent. The sending is done either to the terminal if the processed stream is a stream entering the terminal or to the network 108 if it is a stream sent by the terminal 101.

In one variant of the steps 203, 204 and 205, a session/context table is implemented by the proxy server so as to memorize the decisions taken and the processing operations performed on the stream so as to optimize subsequent processing operations on the same stream. It is indeed interesting to keep the data of the last packet sent, the encipher in key of the session in progress, the state of a context destruction timer in the event of inactivity, the characteristics of the last IP packet sent in a session/context table so as to achieve greater efficiency for the semantic processing operations performed by the application programs in charge of the control for the following IP packets sent or received by the proxy server.

In the step 106, the proxy sends out the data of the stream according to the processing operation applied at the step 205. It may be noted here that the processing operation, especially an enciphering operation, may be delegated by the card 110 to the processor of the terminal. This is relevant because the processing capacities of a microcircuit card are smaller than those of a mobile terminal. In this precise case, a microcircuit card may be responsible for setting up and managing the keys provided through a channel that may or may not be secured (for example through the setting up of the means JSR 177) to an applications program of the mobile in charge of the enciphering/deciphering on-the-fly of the stream (for example in the context of the setting up of enciphered end-to-end videophony, independently of the network to which it belongs).

The steps 204 to 206 are totally transparent for the user of the terminal 101. For the user, everything happens as it would on a normal terminal, i.e. a terminal that does not implement the disclosed embodiments. FIG. 2 also shows a step 211 corresponding actually to the step 203. The step 211 illustrates the fact that the terminal also monitors the reception of a message for updating the memory 117, i.e. a message for updating the configuration of the proxy. If such a message is detected, it is in fact directly processed by the card 110 which, through the configuration of the terminal 101, is a proxy server for all the streams received by the terminal 101.

The card 110 therefore passes to a step 212 for verification of the validity of the configuration message and applies the new configuration, in a step 213, according to the result of the step 212. This mechanism has already been described for a step 201. It may simply be recalled here that the verification of validity relies on the read/right mechanisms of the security domain. The configuration messages therefore sent to the terminal after a connection has been set up between a server and the terminal on the initiative of the server. What is being done is to “push” (using PUSH type technologies) the configuration file in the terminal and more particularly in its microcircuit card.

FIG. 1 shows a server 121 connected to the network 108. This server has at least communications means and at least the following in a simplified way:
a configuration memory 122 enabling the association of an identifier of a mobile telephone, for example an identification number of the terminal or a unique series number of this terminal (typically an IMEI number in the context of a mobile telephone), an IMSI (International Mobile Subscriber Identity) number of a telephone number (MSISDN) with a stream identifier and a behavior identifier, i.e. in fact with a row such as one of the rows of the memory 117. The memory 122 may comprise several roads associating the same IMSI number to several couples [stream identifier, behavior identifier],
a memory 123 enabling an identifier of the terminal to be associated with security parameters, for example a keyset,
a memory 124 comprising instruction codes to produce a configuration message from the contents of the memories 122 and 123.

The server 121 is in charge of synchronizing the memories 117 with the content of the memory 122.

The identifiers of the memories 122 and 123 are of the same nature and correspond to an identifier recorded in a memory 118 of the microcircuit card 110.

In one variant of the disclosed embodiments, by entering a password, checked by the proxy server, the user can modify or complement or even deactivate certain roads of the table 117.

In one variant of the disclosed embodiments, the proxy server is capable of managing, preserving or sending to the terminal and/or an external server which may be specified, a detailed history of the set of update configuration actions performed on the table 117.

Through the disclosed embodiments, it is therefore possible to manage the security of the communications that have come from and are sent to a mobile terminal. This includes voice and videophonic communications because the mobile terminals are capable of setting up communications known as voice on IP communications or VoIP communications. This management is furthermore secured by protection through security mechanisms linked to a security domain of the configuration of the application enabling the management of this security. This security is, by the same read/write mechanisms of the security domain, managed in a centralized way through a server producing and broadcasting the configurations.

Through the disclosed embodiments, the mobile network operators can propose end-to-end security services, intrinsic to their networks by setting up the disclosed embodiments at the level of the SIM/USIM cards and independently of the applications of the terminal in using the proxy server of the SIM/USIM relying only on protocols and streams transmitted on the network. This securing is carried by the operator's SIM/USIM card. It then becomes independent of the transport network and is operational even when the SIM/USIM card is in a “roaming” situation abroad. Then it becomes possible for users to automatically obtain security services as worthwhile as mutual authentication based on cryptographic challenges of interlocutors on a basis of telephony on IP using SIP or H323 and protocols and to ensure, for example, an end-to-end enciphering quality independently of the quality of the application programs used by the terminal. A fleet manager having received, by delegation from the operator, the keysets of its SIM/USIM cards can also guarantee a level of end-to-end confidentiality/enciphering whatever the quality and independently of the presence or absence of malicious codes within application programs used by the terminal (only some streams are conveyed in an enciphered state by the proxy server the others being prohibited by the proxy server). Another immediate advantage of the disclosed embodiments is a possibility for the fleet manager of being able to push its own enciphering application program within the set of SIM/USIM cards of its feet and the driving of this application through the mechanisms set up.

What is claimed is:

1- A method for securing a data stream sent out by an electronic terminal (101), the securing being obtained through a proxy server (115) hosted and implemented in a microcircuit card inserted in the electronic terminal, wherein the method comprises the following steps implemented by the terminal:
it records (201) a configuration of a proxy server in a configuration memory of the microcircuit card for which the rights to update the configuration memory of a set of terminals or fleet of terminals are dedicated to a single entity, the fleet manager, exclusively between fleets of terminals,
it records (202), in a protocol configuration memory, a parameter forcing the use of the proxy server for each data stream of at least one protocol,
it applies (204-206), for each data stream of each protocol parametrized to be submitted to the proxy server, the processing planned for the stream by the configuration of the proxy server.

2- A method according to claim 1 wherein the planned processing is carried out by a dedicated application-specific program.

3- A method according to claim 1 wherein the planned processing is carried out by a specialized server connected to the proxy server.

4- A method according to claim 3 wherein the configuration memory is updated through an updating step (213) following a step of remote connection to the terminal comprising the configuration memory.

5- A method according to claim 1 wherein the configuration memory is updated through an updating step (213) following a step of connection locally to the terminal comprising the configuration memory, this connection step possibly necessitating a phase of authentication of the user.

6- A method according to claim 1, wherein a step of writing in the configuration memory is conditioned by the validation of a step (212) of verification of the rights of the sender of a request for updating the configuration memory.

7- A method according to claim 1 wherein the application programs responsible for the processing operations planned for each of the streams identified by the configuration of the proxy server are updated according to the same methods as those set up for updating the configuration memory, where this updating can be limited to the downloading of cryptographic keys using symmetric or asymmetric technologies necessary for the working of said application program.

8- A method according to claim 1, wherein the proxy server is implemented by a microcircuit card inserted into the electronic terminal.

9- A method according to claim 1, wherein the processing planned for each of the data streams of each parametrized protocol takes account of the information on the time of use.

10- A method according to claim 1, wherein the processing operation planned for each of the data streams of each parametrized protocol takes account of the knowledge of the geolocation of the terminal.

11- A method according to claim 1, wherein processing planned for each of the data streams of each parametrized protocol takes account of the information on the last streams processed.

12- A method according to claim 2 wherein the application-specific programs dedicated to the planned processing may be downloaded into the microcircuit card or activated if they are already resident therein.

13- A method according to claim 1 wherein there is a default security configuration applied to any new terminal of the fleet that does not have any specific configuration.
